(19) United States
(12) Patent Application Publication
(10) Pub. No.: US 2004/0023197 A1
(43) Pub. Date: Feb. 5, 2004

(54) Method and system for providing support when selecting a training program as part of therapy planning

(76) Inventors: Klaus Abraham-Fuchs, Erlangen (DE); Uwe Eisermann, Kufstein (AT); Achim Hein, Nurnberg (DE); Niels Richter, Thurnau (DE); Robert Setz, Rednitzhembach (DE)

Correspondence Address: HARNESS, DICKEY & PIERCE, P.L.C., P.O.BOX 8910, RESTON, VA, 20195, US

(21) Appl. No.: 10/611,932

(22) Filed: Jul. 3, 2003

(30) Foreign Application Priority Data
Jul. 3, 2002 (EP) 02014703.9

(51) Int. Cl. G09B 5/00; G09B 23/28

(52) U.S. Cl. 434/236; 434/262; 434/238; 434/362

(57) ABSTRACT

A method and a system for providing support when selecting a training program as part of therapy planning. A capability profile for a patient and a first database are provided. The first database contains a plurality of past comparative capability profiles for comparative patients and an allocation of training programs respectively prescribed on the basis of these comparative capability profiles. A data processing station automatically compares the patient's capability profile with the comparative capability profiles and selects and displays from the first database, one or more suitable training programs for which the associated comparative capability profile matches the patient's capability profile to a prescribable degree of similarity. The method and the associated system make it easier for the physician or therapist to select an individual training program.

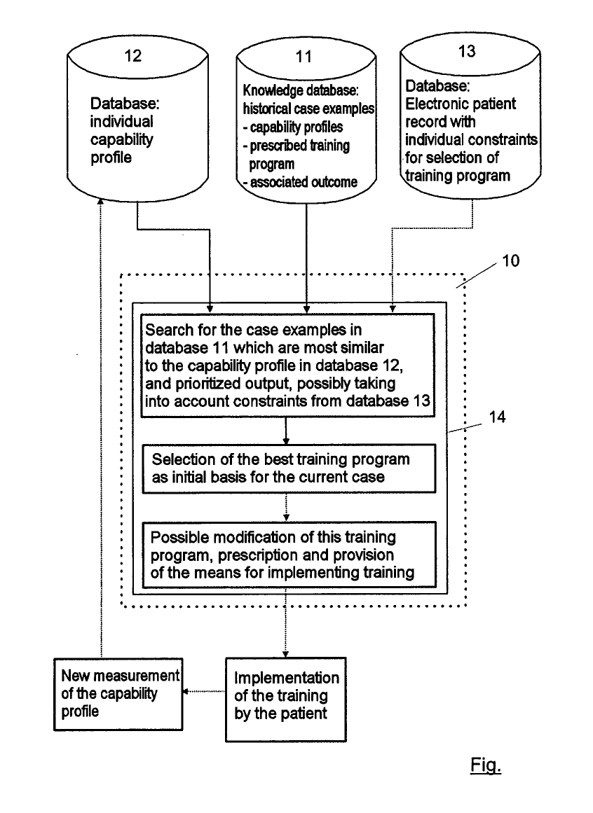

The present application hereby claims priority under 35 U.S.C. §119 on European patent application number EP 02014703.9 filed Jul. 3, 2002, the entire contents of which are hereby incorporated herein by reference.

### FIELD OF THE INVENTION

The present invention generally relates to a method and a system for providing support when selecting a training program as part of therapy planning for rehabilitating a patient.

### BACKGROUND OF THE INVENTION

Serious illnesses such as stroke, heart attack or Alzheimer's disease or serious operations such as the insertion of joint implants or the performance of an amputation cause most patients to have different deficits in physical and mental performance. These deficits are generally the result of the weakening or complete failure of a region of the brain or of a muscle. Combinations of these also frequently arise.

Thus, by way of example, a region of the brain which is responsible for controlling a muscle or a number of muscles in functional chains can be damaged. As a result, the affected muscles degenerate, and thus are no longer able to be used properly. Such mental or physical restrictions are referred to in the medical vernacular as capability deficits, which can be split into various areas of capability.

Thus, one known classification makes the following exemplary distinctions:

motor capabilities such as strength, stamina, mobility, balance, reaction, orientation, differentiation, accommodation, speech motor functions;

intellectual/cognitive capabilities such as attention, memory, planning, comprehension of speech, communication, vision;

organic/physical capabilities such as reduction of organ performance;

social capabilities such as the ability to communicate and participate;

emotional capabilities such as the capability to develop self-esteem.

Some capabilities also require interplay between motor functions and cognitive functions. Thus, by way of example, the activity of climbing stairs requires strength and balance as motor capabilities and attention and spatial awareness as cognitive capabilities.

Very often, a patient does not have a single deficit in one capability category but rather has a combination of a plurality of deficits in a more or less serious form. The aim of a therapeutic measure, which is normally performed as part of a rehabilitation process, is to restore the capabilities or to reduce the existing deficits as far as possible.

At the start of the rehabilitative measure, this generally involves all the patient's capability deficits being recorded using known methods of measurement, observation and questioning, and their extent being documented. This recording process is also referred to as staging the patient. Depending on the methods of measurement used, the result of this staging process is quantitative. For example, a percentage of visual capability or an indication of the degree of mobility in the upper arm, or qualitative, for example a classification of the capability restriction as severe, intermediate or slight. One example of an established method of measurement for staging numerous neurological, cognitive and physical capabilities is the “Wiener test series” from the company Schuhfried.

The result of this initial examination is ideally a cross-discipline capability report which can be presented in the form of a capability profile. In this context, a capability profile is defined as a list of all relevant capabilities and an association between the degree of the restriction in these capabilities for this patient and the time at which the information was collected.

In addition to the term capabilities, the term skill is also used in the medical vernacular. In the context of a medical rehabilitation measure, a skill is understood to refer to a complex action which is self-contained and can be delimited with respect to other actions. A skill requires interplay between a plurality of capabilities.

In particular, the term skill in the context of rehabilitation refers to activities of daily living (ADL) which are a primary prerequisite for independent, autonomous living. Examples of such skills are eating, dressing, washing, showering, climbing stairs, etc. The performance of such skills is also recorded in standardized questionnaires and is quantified as an ADL index. Although rehabilitation directly involves the training of capabilities, the actual aim is to reacquire skills. In this respect, the terms capability and skill can normally be interchanged within the context of the description below.

In the rehabilitation of skills deficits or capability deficits related to illness or accident, an individual training program needs to be compiled for the patient on the basis of the existing deficits. In this case, a training program can include performing an individual exercise with an individually chosen increase in the level of difficulty over time or else performing a plurality of exercises with a particular weighting and in a particular order. The individual training program is selected or compiled by the physician or therapist from his experience.

This experience is based firstly on textbook knowledge and secondly on the observation of many patients in the course of his professional practice. In this context, the physician normally intuitively takes up experience with as closely a related case as possible and transfers a training program which was successful in that case to the new case. In so doing, however, the physician is reliant on his memory and on any existing records. On the other hand, the physician can revert to previous experience only if he has already treated a sufficient number of patients with comparable capability deficits.

### SUMMARY OF THE INVENTION

An object of an embodiment of the present invention is to specify a method and a system for providing support when selecting a training program in therapy planning, which will simplify the work for the physician or therapist and make it independent of his individual previous experience in prescribing training programs.

An object may be achieved by a method and system for providing support of an embodiment of the present invention. Advantageous refinements of the method and of the system can be found in the description below and in the exemplary embodiments.

A method for providing support when selecting a training program in therapy planning involves a capability profile for a patient and a first database being provided. The first database contains a plurality of past comparative capability profiles for comparative patients and an allocation of training programs respectively prescribed on the basis of these comparative capability profiles. A data processing station automatically compares the patient's capability profile with the comparative capability profiles. It further selects from the first database, on the basis of this comparison, a plurality of suitable training programs for which the associated comparative capability profile matches the patient's capability profile to a prescribable degree of similarity, and displays the training programs.

In this case, the first database contains the comparative capability profiles and respectively prescribed training programs for a much larger patient collective than can result from the activity of a single physician. The personal range of experience of the treating physician or therapist, which goes into the decision about the compilation of a training program, is significantly expanded by the method by including the experience of other physicians and of a very much larger patient collective in the decision. In the case of the method and the associated system, the training program is thus no longer selected intuitively on the basis of experience but rather on the basis of evidence. In particular, the quality of the training prescription is no longer dependent on the respective physician's experience to the same extent as has been the case up to now.

The prescribable degree of similarity to which the comparative capability profile needs to match the patient's capability profile can either be prescribed by the physician or therapist or can have been stipulated or can be stipulated by the data processing station. In this context, the degree of similarity can be stipulated, by way of example, such that the comparative capability profiles need to have deficits in the same capabilities as the capability profile of a patient. In addition, it is also possible to specify a maximum number of capability deficits differing from the patient's capability profile as a prescribable degree of similarity for the match.

Finally, the extent of the individual deficits can also be restricted by specifying areas in which the respective comparative capability profiles need to match the patient's capability profile in order for the data processing station to select and display the respectively associated training program. In this case, the degree of similarity can be represented, by way of example, mathematically as a vector in a space opened up by the aforementioned criteria, it then being possible to compare the angle between the vectors and the length of the vectors.

In another form of the present method and of the associated system, the first database additionally contains dimensions for the success of treatment in the respective comparative patients which are associated with the respective training program prescribed for the patient. These dimensions for the successive training on the respectively prescribed training program are preferably displayed by the data processing station together with the selected suitable training program(s).

In one embodiment of the present method, this display can be effected in the order of the size of the associated dimensions for the success of treatment, so that the physician or therapist finds the top position on his computer workstation to be the training program which has attained the best treatment result for a comparative patient in the past. In another embodiment of the present method, the order of display of the selected training programs by the data processing station is chosen on the basis of the degree of the match between the comparative capability profiles and the patient's capability profile. In addition, it is also possible to have the data processing station display only the training programs having the highest dimension, or a dimension which is above a prescribable threshold valve, for the success of treatment.

In the same way, the method and the system can be in a form such that they automatically output a proposal for a training program which is selected by the data processing station on the basis of the match between the comparative capability profiles and the patient's capability profile and the associated dimensions for the success of treatment using prescribable selection rules, which are preferably created by experts. By way of example, the selection rules include “if-then” decisions in connection with threshold values for the degree of similarity of the match between the comparative capability profiles and the patient's capability profile and for the dimensions for the success of treatment. In this context, a training program is characterized by the name of training modules, the duration of exercising and the sequence in time of the training modules and also further parameters, such as the level of difficulty, which are specified more precisely by the individual modules.

In another embodiment of the present method and of the associated system, besides the comparison between the capability profiles, the data processing station automatically checks a match between further patient data for the patient and patient data for the comparative patients and takes it into account in the selection. However, these further patient data additionally need to be contained in the first database. Further patient data which may be relevant to the selection of a training program are, by way of example, the patient's age and sex, his level of education, his professional group and other physical or mental restrictions, such as diabetes, a cardiac pacemaker or the like. In this case, as one alternative, the further patient data for the patient himself can be requested by the data processing station at an input station, so that the physician or therapist needs to input them. They can also be retrieved automatically from an electronic patient record to which the data processing station has access. In this case, the data processing station selects only the training programs which belong to comparative patients, where these constraints, i.e. the further patient data in addition to the capability profile, match the corresponding data for the patient.

Since the capability profile and, if appropriate, further individual constraints in the patient data can be very different, the most similar comparative case found may have ever more significant differences in respect of the current case, so that the associated training program cannot be transferred directly. In this case, the physician or therapist has the option of additionally modifying the proposed or displayed suitable training programs in order to match them to the current case. In all cases, modifying such a training proposal involves less work than completely compiling a training program from scratch.

Using the database which has the comparative patients has the particular advantage that it can continually grow with each newly treated patient. Hence, on the one hand, there is a continually increasing likelihood that an earlier case with a very similar comparative capability profile will be found. On the other hand, the training program which produced the best result, the best outcome, in the past is always proposed automatically. The proposed system is therefore self-learning in this sense.

The database which has the historical patient data for the comparative patients can naturally be anonymized, since it is not necessary to have the reference to the respective comparative patient's name for further use of these data within the context of the present method. In the case of an embodiment of the present method, all capability profiles are collected in the same manner on the basis of existing and recognized assessment schemes, for example on the basis of the Staffelstein index, the Bartel index etc. The dimension for the success of treatment, the “outcome”, is likewise measured on the basis of a standardized method in all patients in the same manner in order to obtain comparable values. Suitable dimensions for the success of treatment can be obtained from the capability profile, the skills profile, the quality-of-life index, the results of staging tests, the results of training exercises etc., preferably measuring the difference in the dimensions in respect of the respective initial state before the start of the training program in question. Naturally, the dimension for the outcome can also be formed from a weighted combination or average of a plurality of subsidiary dimensions.

In another advantageous embodiment of the present method, a current capability profile for the patient is repeatedly provided in the course of therapy, and the data processing station automatically carries out the method steps described above. This renewed search for the capability profile which is now most similar in the first database can produce a deviation from the previously prescribed training program. In this case, a new training program is proposed which, given the constraints which have since changed, was the best in the past on the basis of evidence, i.e. on the basis of the data in the first database. This proposal of a new training program can be taken as the initial basis for modifying the existing training program. Naturally, a further constraint to be borne in mind is that a smooth transfer from the old training program to the new training program is ensured without discontinuity jumps. This can be effected with a corresponding automatic proposal by the data processing station by reverting to a third database, which contains appropriate transfer measures between different training programs.

The present system for supporting therapy planning in the selection of a training program, in one embodiment, accordingly includes a data processing station which is connected to the first database and a module for automatically comparing the patient's capability profile with the comparative capability profiles and for selecting and displaying from the first database one or more suitable training programs for which the associated comparative capability profile matches the patient's capability profile to a prescribable degree of similarity.

In at least one further embodiment of the present system, the data processing station is connected to one or more of the further databases, and the content of the first database and the module are accordingly designed for carrying out the method steps explained above.

### BRIEF DESCRIPTIONS OF THE DRAWINGS

The present method and the associated system are explained again below with reference to an exemplary embodiment in conjunction with the drawing, without limiting the general concept of the invention.

The FIGURE shows an overview of the present method and the associated system in an embodiment of the invention.

### DETAILED DESCRIPTION OF THE PREFERRED EMBODIMENTS

The FIGURE shows an overview of the present method and the associated system in an embodiment of the invention. In the present exemplary embodiment, the process of creating a training program in therapy planning by a physician or therapist using the present method and the associated system in a specific embodiment is illustrated by way of example.

The exemplary system includes a computer workstation (data processing station 10) for therapy planning with a module 14 for automated processing of the data provided by the databases. In this context, the data processing station 10 is connected to a first knowledge database 11, which contains historical case examples with comparative patients and their comparative capability profiles, the training programs prescribed on the basis of these comparative capability profiles and the success of treatment, the outcome, attained with the respective training program. In this case, the measure of the success of treatment, the outcome, is preferably indicated as an improvement in the capability deficits per unit time with a corresponding dimension. In addition, the data processing station 10 is connected to a second database 12, which contains the individual capability profile of the patient who is to be treated. Optionally, the data processing station 10 can also be connected to a third database 13 which, for example in the form of an electronic patient record, contains individual constraints associated with the patient who is to be treated for selecting a training program, such as existing illnesses or other physical or mental restrictions, age, weight or sex.

When carrying out the present method, this exemplary embodiment involves the use of a suitably chosen mathematical measure of distance by the module 14 to select from the first knowledge database 11 those cases which are most similar to the current case. The selection is preferably made in the order of similarity. From these selected most similar cases, those which have the best outcome are in turn prioritized. Finally, the proposals prioritized to this extent are displayed on a monitor, so that they are available to the physician or therapist using the method as the best alternatives for evidence-based selection of a training program for the current patient, in order to support a decision. The physician or therapist then prescribes the appropriate training program, which may additionally be modified by him. The patient is then provided with the means for carrying out training, in line with the prescription.

While the training program is being implemented by the patient, a capability profile for the patient is repeatedly recorded and stored in the second database 12. This recording of the capability profile can take place at regular intervals of time or else after prescribable times. The module 14 in the data processing station 10 then respectively retrieves the patient's current capability profile from the second database 12 and compares it with the historical patient data again. On the basis of this comparison, modification of the prescribed training program is then proposed, if appropriate, which the physician or therapist can in turn accept, modify or reject.

The present method and the associated system assist the physician or therapist in the individual creation of a training program for a patient. The selection of training programs which is proposed to him in this context is made on the basis of evidence and automatically. The simultaneous information about the successes of treatment which have been attained with the proposed training programs allows the training program which is most suitable for the patient, from a historical point of view, to be selected at any time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for providing support when selecting a training program as part of therapy planning, comprising:
providing a capability profile for a patient;
providing a first database, said first database containing a plurality of past comparative capability profiles for comparative patients and an allocation of training programs respectively prescribed based on the comparative capability profiles, wherein a data processing station automatically compares the patient's capability profile with the comparative capability profiles and selects and displays from the first database, at least one suitable training program for which the associated comparative capability profile matches the patient's capability profile to a prescribable degree of similarity.

2. The method as claimed in claim 1, wherein the training programs in the first database additionally include associated dimensions for the success of treatment in the respective comparative patient, and wherein the at least one suitable training program is displayed together with the associated dimension for the success of treatment.

3. The method as claimed in claim 2, wherein a plurality of training programs are displayed in an order of size of the associated dimensions for the success of treatment.

4. The method as claimed in claim 1, wherein a plurality of training programs are displayed in an order of degree of similarity of the match between the associated comparative capability profiles and the patient's capability profile.

5. The method as claimed in claim 2, wherein only the at least one training program, having at least one of the highest dimension for the success of treatment and a dimension for the success of treatment which is above a prescribable threshold value, is displayed.

6. The method as claimed in claim 2, wherein, based on the match between the comparative capability profiles and the patient's capability profile and the dimensions for the success of treatment on the respectively prescribed training programs, the data processing station uses prescribable selection rules to propose a suitable training program which promises an optimum training result for the patient.

7. The method as claimed in claim 1, wherein at least one of proposed and displayed training programs are modifyable by a user.

8. The method as claimed in claim 1, wherein the selection of the at least one training program by the data processing station automatically involves a match between further patient data for the patient and patient data for the comparative patients, which are additionally contained in the first database, being checked and taken into account.

9. The method as claimed in claim 8, wherein the patient's further patient data are at least one of input and retrieved by the data processing station from an electronic patient record.

10. The method as claimed in claim 2, wherein a current capability profile for the patient is repeatedly provided in the course of therapy, the data processing station automatically compares the patient's current capability profile with the comparative capability profiles and selects at least one further training program, and displays them together with the associated dimension for the success of treatment, for which the associated comparative capability profile matches the patient's current capability profile to a prescribable degree of similarity, in order to at least one of replace and modify a training program already prescribed for the patient with a further training program, if appropriate.

11. The method as claimed in claim 10, wherein a third database is provided which contains transfer measures between different training programs, and in the event of the prescribed training program being replaced with a further training program, the data processing station automatically retrieves and outputs transfer measures for this further training program by reverting to the third database.

12. The method as claimed in claim 1, wherein the first database contains anonymized data.

13. A system for providing support when selecting a training program as part of therapy planning, comprising:
a data processing station, coupled to a first database containing a plurality of past comparative capability profiles for comparative patients with an allocation of training programs respectively prescribed based on the comparative capability profiles; and
a module for automatically comparing a capability profile for the patient with the comparative capability profiles and for selecting and displaying from the first database, at least one training program for which the associated comparative capability profile matches the patient's capability profile to a prescribable degree of similarity.

14. The system as claimed in claim 13, wherein the data processing station is coupled to a second database, from which the patient's capability profile is retrievable.

15. The system as claimed in claim 13, wherein the training programs in the first database additionally include associated dimensions for the success of treatment in the respective comparative patient, and wherein the module is designed to display the at least one training program together with the associated dimension for the success of treatment.

16. The system as claimed in claim 15, wherein the module is designed to display a plurality of training programs in an order of size of the associated dimensions for the success of treatment.

17. The system as claimed in claim 15, wherein the module is designed to display a plurality of training programs in an order of degree of similarity of the match between the associated comparative profiles and the patient's capability profile.

18. The system as claimed in claim 15, wherein the module is designed to display only the at least one training program including at least one of a highest dimension for the success of treatment and a dimension for the success of treatment which is above a prescribable threshold value.

19. The system as claimed in claim 15, wherein the module is designed to output a proposal for a suitable training program on the basis of the match between the comparative capability profiles and the patient's capability profile and the dimensions for the success of treatment on the respectively prescribed training programs using prescribable selection rules.

20. The system as claimed in claim 13, wherein the module provides the user with an opportunity to modify at least one of the proposed and displayed training programs.

21. The system as claimed in claim 13, wherein the module is designed for automatically checking and taking into account a match between further patient data for the patient and patient data for the comparative patients, which are additionally contained in the first database.

22. The system as claimed in claim 21, wherein the data processing station includes access to an electronic patient record for the patient, from which the patient's further patient data is retrievable by the module.

23. The system as claimed in claim 13, wherein the module is designed for repeatedly retrieving the patient's capability profile in the course of therapy, for automatically comparing it with the comparative capability profiles in the first database, and for selecting and displaying at least one training program from the first database in order to propose at least one of a different and modified training program, if appropriate, in the event of any deviation from a previously prescribed training program.

24. The system as claimed in claim 23, wherein the data processing station is coupled to a third database containing transfer measures between different training programs, and wherein the module is designed so that, in the event of a different training program being proposed, it outputs transfer measures for this different training program by reverting to the third database.

25. The system as claimed in claim 13, wherein the first database contains anonymized data.

26. A method for providing support when selecting a training program as part of therapy planning, comprising:
providing a capability profile for a patient, wherein a database includes a plurality of past comparative capability profiles for comparative patients and an allocation of training programs respectively prescribed based on the comparative capability profiles;
comparing the patient's capability profile with the comparative capability profiles; and
displaying, from the first database, at least one training program associated with a comparative capability profile resembling the patient's capability profile.

27. The method of claim 26, wherein the step of displaying includes matching the patient's capability profile with a comparative capability profile to a prescribable degree of similarity.

28. The method of claim 26, wherein the steps of comparing and diplaying are performed automatically at a data processing station.

29. The method as claimed in claim 26, wherein the training programs in the first database additionally include associated dimensions for the success of treatment in the respective comparative patient, and wherein the at least one suitable training program is displayed together with the associated dimension for the success of treatment.

30. The method as claimed in claim 29, wherein a plurality of training programs are displayed in an order of size of the associated dimensions for the success of treatment.

31. The method as claimed in claim 2, wherein a plurality of training programs are displayed in an order of degree of similarity of the match between the associated comparative capability profiles and the patient's capability profile.

32. The method as claimed in claim 27, wherein the training programs in the first database additionally include associated dimensions for the success of treatment in the respective comparative patient, and wherein the at least one suitable training program is displayed together with the associated dimension for the success of treatment.

33. The method as claimed in claim 32, wherein a plurality of training programs are displayed in an order of size of the associated dimensions for the success of treatment.

34. The method as claimed in claim 32, wherein a plurality of training programs are displayed in an order of degree of similarity of the match between the associated comparative capability profiles and the patient's capability profile.

35. The system as claimed in claim 14, wherein the training programs in the first database additionally include associated dimensions for the success of treatment in the respective comparative patient, and wherein the module is designed to display the at least one training program together with the associated dimension for the success of treatment.

36. A module of a system for providing support when selecting a training program as part of therapy planning, the system including a data processing station, coupled to a first database containing a plurality of past comparative capability profiles for comparative patients with an allocation of training programs respectively prescribed based on the comparative capability profiles, the module comprising:
means for automatically comparing a capability profile for the patient with the comparative capability profiles; and
means for displaying, from the first database, at least one training program for which the associated comparative capability profile matches the patient's capability profile to a prescribable degree of similarity.

37. A device of a system for providing support when selecting a training program as part of therapy planning, comprising:
a data processing station, coupled to a first database containing a plurality of past comparative capability profiles for comparative patients with an allocation of training programs respectively prescribed based on the comparative capability profiles, wherein a module of the system automatically compares a capability profile for the patient with the comparative capability profiles and selects and displays, from the first database, at least one training program for which the associated comparative capability profile matches the patient's capability profile to a prescribable degree of similarity.
